(19) United States
(12) Patent Application Publication
(10) Pub. No.: US 2024/0284213 A1
(43) Pub. Date: Aug. 22, 2024

(54) METHOD AND APPARATUS OF BEAM FAILURE RECOVERY IN UNLICENSED SPECTRUM

(71) Applicant: SAMSUNG ELECTRONICS CO., LTD., Suwon-si (KR)

(72) Inventors: Anil AGIWAL, Suwon-si (KR); Jaehyuk JANG, Suwon-si (KR)

(21) Appl. No.: 18/584,785

(22) Filed: Feb. 22, 2024

(30) Foreign Application Priority Data
Feb. 22, 2023 (KR) 10-2023-0023908

(51) Int. Cl. H04W 24/08; H04L 43/0811; H04W 74/0816; H04W 76/19

(52) U.S. Cl. CPC H04W 24/08; H04L 43/0811; H04W 74/0816; H04W 76/19

(57) ABSTRACT

The disclosure relates to a 5G or 6G communication system for supporting a higher data transmission rate. A method performed by a user equipment (UE) in a communication system including: receiving a configuration associated with beam failure recovery (BFR) including beam failure detection reference signal (BFD-RS) resources, wherein the BFD-RS resources are configured in an unlicensed band; identifying a first number of beam failure instance indications (BFIs) based on radio link quality associated with the BFD-RS resources; incrementing a BFI counter by the first number; and decrementing the incremented BFI counter in case that information associated with a second number of periods for the BFD-RS resources is received, wherein at least part of the second number of periods is associated with listen before talk (LBT) failure.

### CROSS-REFERENCE TO RELATED APPLICATIONS

This application is based on and claims priority under 35 U.S.C. § 119 to Korean Patent Application No. 10-2023-0023908 filed on Feb. 22, 2023, in the Korean Intellectual Property Office, the disclosure of which is incorporated by reference herein in its entirety.

### BACKGROUND

### 1. Field

The disclosure relates generally to wireless communication systems and, more specifically, the disclosure relates to a method and an apparatus of beam failure recovery (BFR) or radio link recovery (RLM) in unlicensed spectrum (unlicensed band, shared spectrum).

### 2. Description of Related Art

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The present disclosure may provide a method and an apparatus of beam failure recovery (BFR) in unlicensed spectrum.

The present disclosure may provide a method and an apparatus of radio link monitoring (RLM) in unlicensed spectrum.

The technical objects to be achieved by various embodiments of the disclosure are not limited to the technical objects mentioned above, and other technical objects not mentioned may be considered by those skilled in the art from various embodiments of the disclosure to be described below.

According to an embodiment of the disclosure, a method performed by a user equipment (UE) in a communication system includes: receiving a configuration associated with beam failure recovery (BFR) including beam failure detection reference signal (BFD-RS) resources, wherein the BFD-RS resources are configured in an unlicensed band; identifying a first number of beam failure instance indications (BFIs) based on radio link quality associated with the BFD-RS resources; incrementing a BFI counter by the first number; and decrementing the incremented BFI counter in case that information associated with a second number of periods for the BFD-RS resources is received, wherein at least part of the second number of periods is associated with listen before talk (LBT) failure.

According to an embodiment of the disclosure, decrementing the incremented BFI counter is further based on the incremented BFI counter being less than a configured maximum BFI counter.

According to an embodiment of the disclosure, the incremented BFI counter is decremented by a number of BFIs identified based on the information associated with the second number of periods.

According to an embodiment of the disclosure, a beam failure detection timer is restored or restarted in case that the first number of BFIs includes a last BFI.

According to an embodiment of the disclosure, the BFI counter is incremented until the BFI counter reaches a value equal to or higher than the configured maximum BFI counter.

According to an embodiment of the disclosure, the method further comprises: triggering the BFR in case that the BFI counter reaches the value equal to or higher than the maximum BFI counter; and cancelling the BFR based on the information associated with the second number of periods is received.

According to an embodiment of the disclosure, wherein the information associated with the second number is received in: a period of for the BFD-RS resources after a last period of the second number of periods; or a period of for the BFD-RS resources after an offset from the last period of the second number of periods.

According to an embodiment of the disclosure, the information associated with the second number of periods is a bitmap of the second number of bits respectively correspond to the second number of periods.

According to an embodiment of the disclosure, a bit with a first value among the second number of bits indicates that a BFD-RS resource in a corresponding period among the second number of periods is associated with the LBT failure.

According to an embodiment of the disclosure, a bit with a second value among the second number of bits indicates that a BFD-RS resource in a corresponding period among the second number of periods is associated with LBT success.

According to an embodiment of the disclosure, a user equipment (UE) in a communication system including a transceiver, and a processor coupled with the transceiver and configured to: receive a configuration associated with beam failure recovery (BFR) including beam failure detection reference signal (BFD-RS) resources, wherein the BFD-RS resources are configured in an unlicensed band; identify a first number of beam failure instance indications (BFIs) based on radio link quality associated with the BFD-RS resources; increment a BFI counter by the first number; and decrement the incremented BFI counter in case that information associated with a second number of periods for the BFD-RS resources is received, wherein at least part of the second number of periods is associated with listen before talk (LBT) failure.

According to an embodiment of the disclosure, a method performed by a base station in a communication system including: transmitting a configuration associated with beam failure recovery (BFR) including beam failure detection reference signal (BFD-RS) resources, wherein the BFD-RS resources are configured in an unlicensed band; performing listen before talk (LBT) operations for transmissions of the BFD-RS resources; and identifying whether to perform the transmissions of the BFD-RS resources respectively based on the LBT operations.

According to an embodiment of the disclosure, a first number of beam failure instance indications (BFIs) is based on radio link quality associated with the BFD-RS resources.

According to an embodiment of the disclosure, the first number is for increment of a BFI counter.

According to an embodiment of the disclosure, information associated with a second number of periods for the BFD-RS resources is transmitted and at least part of the second number of periods is associated with LBT failure.

According to an embodiment of the disclosure, the information associated with the second number of periods is for decrement of the incremented BFI counter.

According to an embodiment of the disclosure, the decrement of the incremented BFI counter is based on the incremented BFI counter being less than a configured maximum BFI counter.

According to an embodiment of the disclosure, the information associated with the second number of periods is associated with a number of BFIs for the decrement of the incremented BFI counter.

According to an embodiment of the disclosure, the information associated with the second number is transmitted in a period of for the BFD-RS resources after a last period of the second number of periods.

According to an embodiment of the disclosure, the information associated with the second number is transmitted in a period of for the BFD-RS resources after an offset from a last period of the second number of periods.

According to an embodiment of the disclosure, the information associated with the second number of periods is a bitmap of the second number of bits respectively correspond to the second number of periods.

According to an embodiment of the disclosure, a bit with a first value among the second number of bits indicates that a BFD-RS resource in a corresponding period among the second number of periods is not transmitted due to the LBT failure.

According to an embodiment of the disclosure, a bit with a second value among the second number of bits indicates that a BFD-RS resource in a corresponding period among the second number of periods is transmitted.

According to an embodiment of the disclosure, a base station in a communication system including a transceiver, and a processor coupled with the transceiver and configured to: transmit a configuration associated with beam failure recovery (BFR) including beam failure detection reference signal (BFD-RS) resources, wherein the BFD-RS resources are configured in an unlicensed band; perform listen before talk (LBT) operations for transmissions of the BFD-RS resources; and identify whether to perform the transmissions of the BFD-RS resources respectively based on the LBT operations.

According to an embodiment of the disclosure, a first number of beam failure instance indications (BFIs) is based on radio link quality associated with the BFD-RS resources.

According to an embodiment of the disclosure, the first number is for increment of a BFI counter.

According to an embodiment of the disclosure, information associated with a second number of periods for the BFD-RS resources is transmitted and at least part of the second number of periods is associated with LBT failure.

According to an embodiment of the disclosure, the information associated with the second number of periods is for decrement of the incremented BFI counter.

The above-described various embodiments of the disclosure are merely some of the preferred embodiments of the disclosure, and various embodiments reflecting the technical features of the disclosure may be derived and understood by those skilled in the art based on the following detailed description of the disclosure.

The disclosure may provide a method and an apparatus of beam failure recovery (BFR) in unlicensed spectrum.

The disclosure may provide a method and an apparatus of radio link monitoring (RLM) in unlicensed spectrum.

The effects that can be achieved through the disclosure are not limited to the effects mentioned in the various embodiments, and other effects not mentioned will be clearly understood by those skilled in the art from the description below.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a method for communication associated with beam failure detection between a UE and a base station according to an embodiment of the present disclosure;

FIG. 2 illustrates an example of a method for communication associated with beam failure detection between a UE and a base station according to an embodiment of the present disclosure;

FIG. 3 illustrates an example of a method for communication associated with beam failure detection between a UE and a base station according to an embodiment of the present disclosure;

FIG. 4 illustrates an example of a method for communication associated with beam failure detection between a UE and a base station according to an embodiment of the present disclosure;

FIG. 5 illustrates an example of a method for communication associated with beam failure detection between a UE and a base station according to an embodiment of the present disclosure;

FIG. 6 illustrates an example of a method for communication associated with beam failure detection between a UE and a base station according to an embodiment of the present disclosure;

FIG. 7 illustrates an example of a method for communication associated with radio link monitoring between a UE and a base station according to an embodiment of the present disclosure;

FIG. 8 illustrates an example of a method for communication associated with radio link monitoring between a UE and a base station according to an embodiment of the present disclosure;

FIG. 9 illustrates an example of a method for communication associated with radio link monitoring between a UE and a base station according to an embodiment of the present disclosure;

FIG. 10 illustrates an example of a method for communication associated with radio link monitoring between a UE and a base station according to an embodiment of the present disclosure;

FIG. 11 illustrates an example of a method for communication associated with radio link monitoring between a UE and a base station according to an embodiment of the present disclosure;

FIG. 12 illustrates an example of a method for communication associated with radio link monitoring between a UE and a base station according to an embodiment of the present disclosure;

FIG. 13 illustrates an electronic device according to embodiments of the present disclosure; and

FIG. 14 illustrates a base station according to embodiments of the present disclosure.

### DETAILED DESCRIPTION

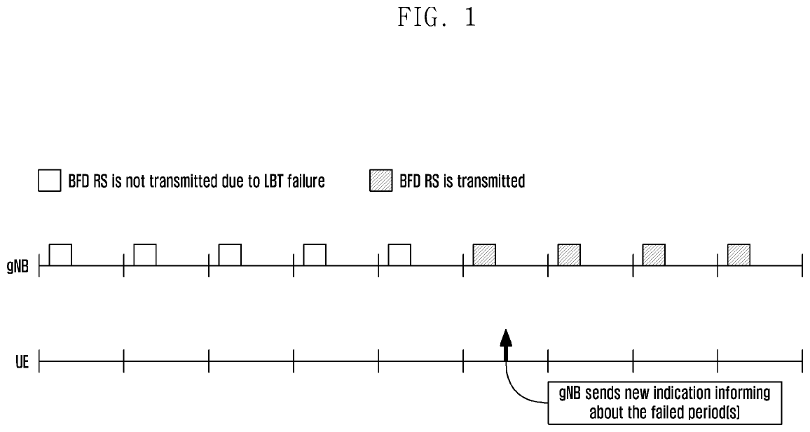

FIGS. 1 through 14, discussed below, and the various embodiments used to describe the principles of the disclosure in this patent document are by way of illustration only and should not be construed in any way to limit the scope of the disclosure. Those skilled in the art will understand that the principles of the disclosure may be implemented in any suitably arranged system or device.

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit,” “module” or the like may refer to a software component or hardware component, such as, for example, a field-programmable gate array (FPGA) or an application-specific integrated circuit (ASIC) capable of carrying out a function or an operation. However, a “unit,” or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5gNB), or gNB.

The “UE” is an entity communicating with a BS and may be referred to as UE, device, mobile station (MS), mobile equipment (ME), or terminal.

In the recent years, several broadband wireless technologies have been developed to meet the growing number of broadband subscribers and to provide more and better applications and services. The second generation wireless communication system has been developed to provide voice services while ensuring the mobility of users. Third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. So, fifth generation wireless communication system (also referred as next generation radio or NR) is being developed to meet the growing demand for high speed data services, support ultra-reliability and low latency applications.

The fifth generation wireless communication system supports not only lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive Multiple-Input Multiple-Output (MIMO), Full Dimensional MIMO (FD-MIMO), array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system would be flexible enough to serve the UEs having quite different capabilities depending on the use case and market segment the UE cater service to the end customer. Few example, use cases the fifth generation wireless communication system wireless system is expected to address is enhanced Mobile Broadband (eMBB), massive Machine Type Communication (m-MTC), ultra-reliable low latency communication (URLLC) etc. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the Internet of Things (IoT)/Internet of Everything (IoE) envisioning connectivity of billions of devices. The URLL requirements like very low latency, very high reliability and variable mobility so on and so forth address the market segment representing the Industrial automation application, vehicle-to-vehicle/vehicle-to-infrastructure communication foreseen as one of the enablers for autonomous cars.

In the fifth generation wireless communication system operating in higher frequency (mmWave) bands, UE and gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end.

In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance.

Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal.

By using beamforming technique, a transmitter can make plurality of transmit beam patterns of different directions. Each of these transmit beam patterns can be also referred as transmit (TX) beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of receive (RX) beam patterns of different directions. Each of these receive patterns can be also referred as receive (RX) beam.

The fifth generation wireless communication system, supports standalone mode of operation as well dual connectivity (DC). In DC, a multiple Rx/Tx UE may be configured to utilise resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in RRC_CONNECTED is configured to utilise radio resources provided by two distinct schedulers, located in two different nodes connected via a non-ideal backhaul and providing either Evolved Universal Terrestrial Radio Access (E-UTRA) (i.e., if the node is an next generation evolved Node-B (ng-eNB)) or NR access (i.e., if the node is a gNB).

In NR for a UE in RRC_CONNECTED not configured with carrier aggregation/dual connectivity (CA/DC), there is only one serving cell comprising of the primary cell. For a UE in RRC_CONNECTED configured with CA/DC the term “serving cells” is used to denote the set of cells comprising of the special cell(s) and all secondary cells. In NR, the term master cell group (MCG) refers to a group of serving cells associated with the Master Node, comprising of the primary cell (PCell) and optionally one or more secondary cells (SCells). In NR, the term secondary cell group (SCG) refers to a group of serving cells associated with the secondary node, comprising of the primary secondary cell (or primary SCG cell) (PSCell) and optionally one or more SCells. In NR PCell (primary cell) refers to a serving cell in MCG, operating on the primary frequency, in which the UE either performs the initial connection establishment procedure or initiates the connection re-establishment procedure. In NR for a UE configured with CA, SCell is a cell providing additional radio resources on top of special cell. PSCell refers to a serving cell in SCG in which the UE performs random access when performing the reconfiguration with a sync procedure. For a dual connectivity operation the term SpCell (i.e., Special Cell) refers to the PCell of the MCG or the PSCell of the SCG, otherwise the term Special Cell refers to the PCell.

In the fifth generation wireless communication system, physical downlink control channel (PDCCH) is used to schedule downlink (DL) transmissions on physical downlink shared channel (PDSCH) and uplink (UL) transmissions on physical uplink shared channel (PUSCH), where the downlink control information (DCI) on PDCCH includes at least one of: downlink assignments containing at least modulation and coding format, resource allocation, and hybrid-ARQ (HARQ) information related to DL-SCH; uplink scheduling grants containing at least modulation and coding format, resource allocation, and hybrid-ARQ information related to uplink shared channel (UL-SCH). In addition to scheduling, PDCCH can be used to for at least one of: activation and deactivation of configured PUSCH transmission with configured grant;
activation and deactivation of PDSCH semi-persistent transmission; notifying one or more UEs of the slot format; notifying one or more UEs of the physical resource block(s) (PRB(s)) and orthogonal frequency division multiplexing (OFDM) symbol(s) where the UE may assume no transmission is intended for the UE; transmission of TPC commands for physical uplink control channel (PUCCH) and PUSCH; transmission of one or more transmit power control (TPC) commands for sounding reference signal (SRS) transmissions by one or more UEs; switching a UE's active bandwidth part; Initiating a random access procedure.

A UE monitors a set of PDCCH candidates in the configured monitoring occasions in one or more configured control resource SETs (CORESETs) according to the corresponding search space configurations. A CORESET consists of a set of PRBs with a time duration of 1 to 3 OFDM symbols. The resource units resource element groups (REGs) and control channel elements (CCEs) are defined within a CORESET with each CCE comprising a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own demodulation reference signal (DMRS). Quadrature phase shift keying (QPSK) modulation is used for PDCCH.

In fifth generation wireless communication system, a list of search space configurations is signalled by gNB for each configured BWP wherein each search space configuration is uniquely identified by an identifier. Identifier of search space configuration to be used for specific purpose such as paging reception, SI reception, random access response reception is explicitly signaled by gNB. In NR search space configuration comprises of parameters monitoring-periodicity-PDCCH-slot, monitoring-offset-PDCCH-slot, monitoring-symbols-PDCCH-within-slot and duration. A UE determines PDCCH monitoring occasion (s) within a slot using the parameters PDCCH monitoring periodicity (monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots “x” to x+duration where the slot with number “x” in a radio frame with number “y” satisfies the equation below:

(y*(number of slots in a radio frame)+x−Monitoring-offset-PDCCH-slot)mod(Monitoring-periodicity-PDCCH-slot)=0.

The starting symbol of a PDCCH monitoring occasion in each slot having PDCCH monitoring occasion is given by monitoring-symbols-PDCCH-within-slot. The length (in symbols) of a PDCCH monitoring occasion is given in the corset associated with the search space. Search space configuration includes the identifier of CORESET configuration associated with it. A list of CORESET configurations is signalled by a gNB for each configured BWP wherein each CORESET configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depend radio frame for each supported SCS is pre-defined in NR.

Each CORESET configuration is associated with a list of transmission configuration indicator (TCI) states. One downlink reference signal (DL RS) identifier (ID) (SSB or channel state information reference signal (CSI RS)) is configured per TCI state. The list of TCI states corresponding to a CORESET configuration is signaled by gNB via radio resource control (RR)C signalling. One of the TCI states in TCI state list is activated and indicated to UE by gNB via medium access control (MAC) control element (CE). TCI state indicates the DL TX beam (DL TX beam is quasi co-located (QCLed) with SSB/CSI RS of TCI state) used by gNB for transmission of PDCCH in the PDCCH monitoring occasions of a search space.

In fifth generation wireless communication system bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can be moved in the frequency domain (e.g., to increase scheduling flexibility); and the subcarrier spacing can be ordered to change (e.g., to allow different services). A subset of the total cell bandwidth of a cell is referred to as a bandwidth part (BWP). BA is achieved by configuring RRC connected UE with BWP(s) and telling the UE which of the configured BWPs is currently the active one. When BA is configured, the UE only has to monitor PDCCH on the one active BWP i.e., it does not have to monitor PDCCH on the entire DL frequency of the serving cell.

In an RRC connected state, UE is configured with one or more DL and UL BWPs, for each configured Serving Cell (i.e., PCell or SCell). For an activated Serving Cell, there is always one active UL and DL BWP at any point in time. The BWP switching for a serving cell is used to activate an inactive BWP and deactivate an active BWP at a time. The BWP switching is controlled by the PDCCH indicating a downlink assignment or an uplink grant, by the bwp-InactivityTimer, by RRC signaling, or by the MAC entity itself upon initiation of random access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a serving cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

In the 5G wireless communication system, random access (RA) is supported. random access (RA) is used to achieve uplink (UL) time synchronization. RA is used during initial access, handover, radio resource control (RRC) connection re-establishment procedure, scheduling request (SR) transmission, secondary cell group (SCG) addition/modification, beam failure recovery and data or control information transmission in UL by non-synchronized UE in an RRC CONNECTED state. Several types of random access procedure are supported.

Contention based random access (CBRA) is described. This is also referred as 4 step CBRA. In this type of random access, UE first transmits Random Access preamble (also referred as Msg1) and then waits for random access response (RAR) in the RAR window. RAR is also referred as message 2 (Msg2). Next generation node B (gNB) transmits the RAR on physical downlink shared channel (PDSCH). PDCCH scheduling the PDSCH carrying RAR is addressed to random access (RA)-radio network temporary identifier (RA-RNTI).

RA-RNTI identifies the time-frequency resource (also referred as physical RA channel (PRACH) occasion or PRACH transmission (TX) occasion or RA channel (RACH) occasion) in which RA preamble was detected by gNB. The RA-RNTI is calculated as follows:

RA-RNTI=1+s_id+14*t_id+14*80*f_id+14*80*8*ul_carrier_id,

where s_id is the index of the first orthogonal frequency division multiplexing (OFDM) symbol of the PRACH occasion where UE has transmitted Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier.

Several RARs for various random access preambles detected by gNB can be multiplexed in the same RAR medium access control (MAC) protocol data unit (PDU) by gNB. An RAR in MAC PDU corresponds to UE's RA preamble transmission if the RAR includes an RA preamble identifier (RAPID) of RA preamble transmitted by the UE. If the RAR corresponding to its RA preamble transmission is not received during the RAR window and the UE has not yet transmitted the RA preamble for a configurable (configured by gNB in RACH configuration) number of times, the UE goes back to first step i.e., select random access resource (preamble/RACH occasion) and transmits the RA preamble. A backoff may be applied before going back to first step.

If the RAR corresponding to its RA preamble transmission is received the UE transmits message 3 (Msg3) in UL grant received in RAR. Msg3 includes message such as RRC connection request, RRC connection re-establishment request, RRC handover confirm, scheduling request, SI request etc. It may include the UE identity (i.e., cell-radio network temporary identifier (C-RNTI) or system architecture evolution (SAE)-temporary mobile subscriber identity (S-TMSI) or a random number).

After transmitting the Msg3, a UE starts a contention resolution timer. While the contention resolution timer is running, if the UE receives a physical downlink control channel (PDCCH) addressed to C-RNTI included in Msg3, contention resolution is considered successful, contention resolution timer is stopped and the RA procedure is completed. While the contention resolution timer is running, if the UE receives contention resolution MAC control element (CE) including the UE's contention resolution identity (first X bits of common control channel (CCCH) service data unit (SDU) transmitted in Msg3), contention resolution is considered successful, contention resolution timer is stopped and the RA procedure is completed. If the contention resolution timer expires and UE has not yet transmitted the RA preamble for a configurable number of times, the UE goes back to first step i.e., select random access resource (preamble/RACH occasion) and transmits the RA preamble. A backoff may be applied before going back to first step.

Contention free random access (CFRA) is described. This is also referred as legacy CFRA or 4 step CFRA. A CFRA procedure is used for scenarios such as handover where low latency is required, timing advance establishment for secondary cell (SCell), etc. Evolved node B (eNB) assigns to UE dedicated random access preamble. A UE transmits the dedicated RA preamble. The eNB transmits the RAR on PDSCH addressed to RA-RNTI. RAR conveys RA preamble identifier and timing alignment information. RAR may also include UL grant. RAR is transmitted in RAR window similar to contention based RA (CBRA) procedure. CFRA is considered successfully completed after receiving the RAR including RA preamble identifier (RAPID) of RA preamble transmitted by the UE. In case RA is initiated for beam failure recovery, CFRA is considered successfully completed if PDCCH addressed to C-RNTI is received in search space for beam failure recovery. If the RAR window expires and RA is not successfully completed and the UE has not yet transmitted the RA preamble for a configurable (configured by gNB in RACH configuration) number of times, the UE retransmits the RA preamble.

For certain events such as handover and beam failure recovery if dedicated preamble(s) are assigned to a UE, during first step of random access i.e., during random access resource selection for Msg1 transmission the UE determines whether to transmit dedicated preamble or non dedicated preamble. Dedicated preambles are typically provided for a subset of SSBs/CSI RSs. If there is no SSB/CSI RS having DL RSRP above a threshold amongst the SSBs/CSI RSs for which contention free random access resources (i.e., dedicated preambles/RACH occasions (ROs)) are provided by gNB, UE select non dedicated preamble. Otherwise, the UE select dedicated preamble. So, during the RA procedure, one random access attempt can be CFRA while other random access attempt can be CBRA.

2 step contention based random access (2 step CBRA) is described. In the first step, the UE transmits random access preamble on PRACH and a payload (i.e., MAC PDU) on PUSCH. The random access preamble and payload transmission is also referred as message A (MsgA). In the second step, after MsgA transmission, the UE monitors for a response from the network (i.e., gNB) within a configured window. The response is also referred as message B (MsgB).

If CCCH SDU was transmitted in MsgA payload, the UE performs contention resolution using the contention resolution information in MsgB. The contention resolution is successful if the contention resolution identity received in MsgB matches first 48 bits of CCCH SDU transmitted in MsgA. If C-RNTI was transmitted in MsgA payload, the contention resolution is successful if UE receives PDCCH addressed to C-RNTI. If contention resolution is successful, random access procedure is considered successfully completed. Instead of contention resolution information corresponding to the transmitted MsgA, MsgB may include a fallback information corresponding to the random access preamble transmitted in MsgA. If the fallback information is received, the UE transmits Msg3 and performs contention resolution using message 4 (Msg4) as in CBRA procedure. If contention resolution is successful, random access procedure is considered successfully completed. If contention resolution fails upon fallback (i.e., upon transmitting Msg3), the UE retransmits MsgA. If configured window in which the UE monitor network response after transmitting MsgA expires and the UE has not received MsgB including contention resolution information or fallback information as explained above, UE retransmits MsgA. If the random access procedure is not successfully completed even after transmitting the MsgA configurable number of times, UE fallbacks to 4 step RACH procedure i.e., the UE only transmits the PRACH preamble.

MsgA payload may include one or more of common control channel (CCCH) service data unit (SDU), dedicated control channel (DCCH) SDU, dedicated traffic channel (DTCH) SDU, buffer status report (BSR) MAC control element (CE), power headroom report (PHR) MAC CE, SSB information, C-RNTI MAC CE, or padding. MsgA may include UE ID (e.g., random ID, S-TMSI, C-RNTI, resume ID, etc.) along with preamble in first step. The UE ID may be included in the MAC PDU of the MsgA. The UE ID such as C-RNTI may be carried in MAC CE wherein MAC CE is included in MAC PDU. Other UE IDs (such random ID, S-TMSI, C-RNTI, resume ID, etc.) may be carried in CCCH SDU. The UE ID can be one of random ID, S-TMSI, C-RNTI, resume ID, IMSI, idle mode ID, inactive mode ID, etc.

The UE ID can be different in different scenarios in which the UE performs the RA procedure. When the UE performs RA after power on (before it is attached to the network), then UE ID is the random ID. When the UE performs RA in an IDLE state after it is attached to network, the UE ID is S-TMSI. If the UE has an assigned C-RNTI (e.g., in connected state), the UE ID is C-RNTI.

In case the UE is in an INACTIVE state, the UE ID is a resume ID. In addition to the UE ID, some addition control (ctrl) information can be sent in MsgA. The control information may be included in the MAC PDU of the MsgA. The control information may include one or more of connection request indication, connection resume request indication, SI request indication, buffer status indication, beam information (e.g., one or more DL TX beam ID(s) or SSB ID(s)), beam failure recovery indication/information, data indicator, cell/BS/TRP switching indication, connection re-establishment indication, reconfiguration complete or handover complete message, etc.

2 step contention free random access (2 step CFRA) is described. In this case the gNB assigns to UE dedicated random access preamble (s) and PUSCH resource(s) for MsgA transmission. RO(s) to be used for preamble transmission may also be indicated. In the first step, UE transmits random access preamble on PRACH and a payload on PUSCH using the contention free random access resources (i.e., dedicated preamble/PUSCH resource/RO). In the second step, after MsgA transmission, the UE monitors for a response from the network (i.e., gNB) within a configured window. If the UE receives PDCCH addressed to C-RNTI, random access procedure is considered successfully completed. If the UE receives fallback information corresponding to its transmitted preamble, random access procedure is considered successfully completed.

For certain events such has handover and beam failure recovery if dedicated preamble(s) and PUSCH resource(s) are assigned to a UE, during first step of random access i.e., during random access resource selection for MsgA transmission the UE determines whether to transmit dedicated preamble or non dedicated preamble. Dedicated preambles are typically provided for a subset of SSBs/CSI RSs. If there is no SSB/CSI RS having DL RSRP above a threshold amongst the SSBs/CSI RSs for which contention free random access resources (i.e., dedicated preambles/ROs/PUSCH resources) are provided by a gNB, the UE selects non dedicated preamble. Otherwise, the UE selects dedicated preamble. So, during the RA procedure, one random access attempt can be 2 step CFRA while other random access attempt can be 2 step CBRA.

Upon initiation of random access procedure, the UE first selects the carrier (SUL or NUL). If the carrier to use for the random Access procedure is explicitly signalled by the gNB, the UE select the signalled carrier for performing random Access procedure. If the carrier to use for the random Access procedure is not explicitly signalled by the gNB; and if the serving cell for the random access procedure is configured with supplementary uplink and if the RSRP of the downlink pathloss reference is less than rsrp-ThresholdSSB-SUL: the UE selects the SUL carrier for performing random access procedure. Otherwise, the UE selects the NUL carrier for performing random access procedure. Upon selecting the UL carrier, the UE determines the UL and DL BWP for random access procedure as specified in TS 38.321. the UE then determines whether to perform 2 step or 4 step RACH for this random access procedure.
If this random access procedure is initiated by PDCCH order and if the ra-PreambleIndex explicitly provided by PDCCH is not 0b000000, the UE selects 4 step RACH.
else if 2 step contention free random access resources are signaled by gNB for this random access procedure, the UE selects 2 step RACH.
else if 4 step contention free random access resources are signaled by gNB for this random access procedure, the UE selects 4 step RACH.
else if the UL BWP selected for this random access procedure is configured with only 2 step RACH resources, the UE selects 2 step RACH.
else if the UL BWP selected for this random access procedure is configured with only 4 step RACH resources, the UE selects 4 step RACH.
else if the UL BWP selected for this random access procedure is configured with both 2 step and 4 step RACH resources,
if RSRP of the downlink pathloss reference is below a configured threshold, UE selects 4 step RACH. Otherwise, the UE selects 2 step RACH.

In the fifth generation wireless communication system, node B (gNB) or base station in cell broadcast synchronization signal and physical broadcast channel (PBCH) block (SSB) consists of primary and secondary synchronization signals (PSS, SSS) and system information. System information includes common parameters needed to communicate in cell. In the fifth generation wireless communication system (also referred as next generation radio or NR), system information (SI) is divided into the master information block (MIB) and a number of system information blocks (SIBs) where:
the MIB is always transmitted on the broadcast channel (BCH) with a periodicity of 80 ms and repetitions made within 80 ms and it includes parameters that are needed to acquire SIB1 from the cell.

The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. The scheduling information in SIB 1 includes mapping between SIBs and SI messages, periodicity of each SI message and SI window length. The scheduling information in SIB 1 includes an indicator for each SI message, which indicates whether the concerned SI message is being broadcasted or not. If at least one SI message is not being broadcasted, SIB1 may include random access resources (physical random access channel (PRACH) preamble(s) and PRACH resource(s)) for requesting gNB to broadcast one or more SI message(s).

SIBs other than SIB1 are carried in system information (SI) messages, which are transmitted on the DL-SCH. Only SIBs having the same periodicity can be mapped to the same SI message. Each SI message is transmitted within periodically occurring time domain windows (referred to as SI-windows with same length for all SI messages). Each SI message is associated with a SI-window and the SI-windows of different SI messages do not overlap. That is, within one SI-window only the corresponding SI message is transmitted. Any SIB except SIB1 can be configured to be cell specific or area specific, using an indication in SIB1. The cell specific SIB is applicable only within a cell that provides the SIB while the area specific SIB is applicable within an area referred to as SI area, which consists of one or several cells and is identified by systemInformationAreaID.

The fifth generation wireless communication system supports beam failure detection and recovery mechanism at a UE for a serving cell. This comprises of beam failure detection, new candidate beam identification, beam failure recovery request transmission and monitoring response for beam failure recovery request. For beam failure detection of a serving cell, the UE is configured with a list of beam failure detection reference signals (RSs) (SSB or channel state information reference signal (CSI-RS) based) for that serving cell. The UE monitors these RSs periodically. A beam failure is detected on a serving cell if number of consecutive detected beam failure instance exceeds a configured maximum number (beamFailureInstanceMaxCount) within a configured time (beamFailureDetectionTimer). A Beam failure instance means that hypothetical PDCCH BLER determined based on measurement of beam failure detection RS is above a threshold for all beam failure detection RSs. Beam failure detection may be configured for zero or one or more serving cells. Upon beam failure instance, lower layer i.e., physical layer (PHY) sends indication to MAC. The MAC entity in the UE for each the serving cell configured for beam failure detection, perform the following operation:
1> if beam failure instance indication has been received from lower layers:
2> start or restart the beamFailureDetectionTimer;
2> increment BFI_COUNTER by 1;
2> if BFI_COUNTER >=beamFailureInstanceMaxCount:
3> if the Serving Cell is SCell:
4> trigger a BFR for this serving cell;
3> else:
4> initiate a random access procedure on the SpCell.
1> if the beamFailureDetectionTimer expires; or
1> if beamFailureDetectionTimer, beamFailureInstanceMaxCount, or any of the reference signals used for beam failure detection is reconfigured by upper layers (i.e., RRC) associated with this serving cell:
2> set BFI_COUNTER to 0.
1> if the Serving Cell is SpCell and the random access procedure initiated for SpCell beam failure recovery is successfully completed:
2> set BFI_COUNTER to 0;
2> stop the beamFailureRecoveryTimer, if configured;
2> consider the beam failure recovery procedure successfully completed.
1> else if the serving cell is SCell, and a PDCCH addressed to C-RNTI indicating uplink grant for a new transmission is received for the HARQ process used for the transmission of the BFR MAC CE or Truncated BFR MAC CE which contains beam failure recovery information of this Serving Cell; or
1> if the SCell is deactivated:
2> set BFI_COUNTER to 0;
2> consider the beam failure recovery procedure successfully completed and cancel all the triggered BFRs for this serving cell.

The MAC entity may:
1> if the beam failure recovery procedure determines that at least one BFR has been triggered and not cancelled:
2> if UL-SCH resources are available for a new transmission and if the UL-SCH resources can accommodate the BFR MAC CE plus its subheader as a result of LCP:
3> instruct the Multiplexing and Assembly procedure to generate the BFR MAC CE.
2> else if UL-SCH resources are available for a new transmission and if the UL-SCH resources can accommodate the truncated BFR MAC CE plus its subheader as a result of LCP:
3> instruct the multiplexing and Assembly procedure to generate the truncated BFR MAC CE.
2> else:
3> trigger the SR for SCell beam failure recovery for each SCell for which BFR has been triggered and not cancelled.

All BFRs triggered prior to MAC PDU assembly for beam failure recovery for an SCell may be cancelled when a MAC PDU is transmitted and this PDU includes a BFR MAC CE or Truncated BFR MAC CE which contains beam failure information of that SCell.

beamFailureInstanceMaxCount, beamFailureDetectionTimer, beamFailureRecoveryTimer for the beam failure recovery procedure are specific to serving cell. BFI_COUNTER is maintained separately for each serving cell configured with beam failure detection.

Embodiments of the disclosure will be described in detail with reference to the accompanying drawings. A base station refers to an entity that allocates resources to a terminal, and may be at least one of a gNode B, a gNB, an eNode B, a node B, a base station (BS), a radio access unit, a base station controller, or a node on a network. A terminal may include user equipment (UE), a mobile station (MS), a cellular phone, a smart phone, a computer, or a multimedia system capable of performing a communication function. Although embodiments of the disclosure will be described with reference to a 5G system as an example, embodiments of the disclosure are also applicable to other communication systems having similar technical backgrounds or channel types. For example, mobile communication technologies developed after 5G may be included therein. Therefore, embodiments of the disclosure are also applicable to other communication systems through a partial modification without substantially deviating from the scope of the disclosure as deemed by those skilled in the art. The embodiments of the disclosure described hereinafter may be applied simultaneously or in combination.

For detecting beam failure in a serving cell, UE is configured with beam failure detection reference signal (BFD-RS) resource(s). On each BFD-RS resource, the UE estimates the downlink radio link quality and compare it to the thresholds Q_{out_LR}. Qₒᵤₜ is the level at which the downlink radio link cannot be reliably received and corresponds to the block error rate (BLER_{out_LR} of 10%). Beam Failure Instance indication is sent by physical layer (L1) to MAC layer when downlink radio link quality on all the configured BFD-RS resources is worse than Q_{out_LR} If beam failure instance indication has been received from lower layers (i.e., L1), MAC entity performs the following operation:
increment BFI_COUNTER by 1; and
if BFI_COUNTER>=beamFailureInstanceMaxCount: trigger BFR.

For beam failure detection in a serving cell, a gNB periodically transmit BFD RS(s). In case of unlicensed spectrum (i.e., shared spectrum), the gNB needs to perform listen before talk (LBT) before transmitting BFD RS. In case of LBT failure, the gNB does not transmit the periodic BFD RSs. As a result, beam failure is detected by a UE (even though there is no beam failure). PHY layer in the UE sends beam failure instance indication to MAC and MAC increments the BFI_COUNTER. This may result in false BFR trigger. So, enhancement is needed.

### Method 1

FIGS. 1 through 4 illustrate examples of methods for communication associated with beam failure detection between a UE and a base station according to an embodiment of the disclosure.

Referring FIGS. 1-4, connection is established between the UE and the gNB. The UE is configured with one or more serving cells. For detecting beam failure for a serving cell or for detecting beam failure for transmission and reception point (TRP) (or BFD-RS set) of a serving cell, the UE is configured with BFD-RS resource(s). The gNB periodically transmits BFD-RS(s) in these resources. In case that unlicensed spectrum (or unlicensed frequency or unlicensed carrier or shared spectrum) is used for a serving cell, the gNB needs to perform LBT operation before transmitting BFD-RS in the BFD-RS resource. In case of LBT failure (i.e., channel is not free for transmitting on BFD-RS resource), gNB does not transmit BFD-RS in the BFD-RS resource. In case that LBT is successful, gNB transmits BFD-RS in the BFD-RS resource.

On each BFD-RS resource, the UE estimates the downlink radio link quality and compare it to the thresholds Q_{out_LR}. Qₒᵤₜ is the level at which the downlink radio link cannot be reliably received and corresponds to the block error rate (BLER_{out_LR} of 10%). Beam Failure Instance indication is sent by physical layer (L1) to MAC layer when downlink radio link quality on all the configured BFD-RS resources is worse than Q_{out_LR}. If beam failure instance indication has been received from lower layers (i.e., L1), MAC entity performs the following operation:
increment BFI_COUNTER by 1; and
if BFI_COUNTER>=beamFailureInstanceMaxCount: trigger BFR.

Referring FIG. 1, in a method of this disclosure, gNB may inform/indicate a UE about the failure of BFD RS transmission(s) (for example, as shown in FIG. 1 gNB may indicate that BFD RS RS is not transmitted in 5 periods due to LBT failure) due to LBT failure. The gNB may provide a new indication informing about the failed periods. This information/indication may be sent to the UE via DCI or MAC CE or RRC message. In an embodiment, the UE may indicate whether it has capability (e.g., using RRC message such as UE capability information message or UE assistance information message or any other message) for such enhancement and if/only if the UE has such capability, the gNB provides the above information/indication.

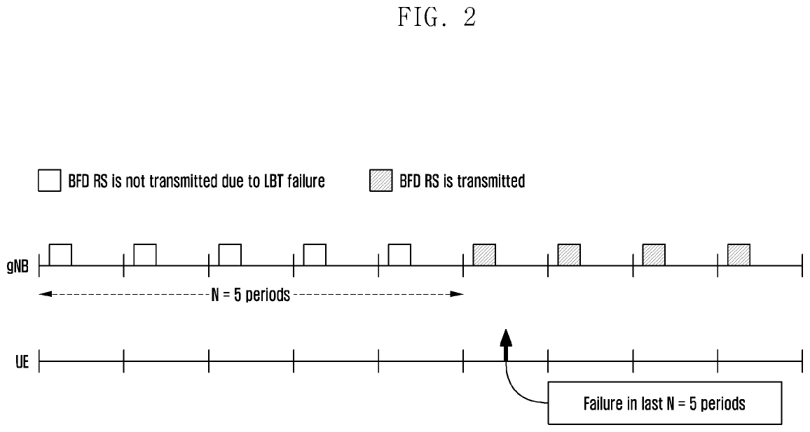

Referring FIG. 2, in an embodiment, the indication/information may be transmitted in first period in which BFD RS is transmitted after the failure(s). The gNB may indicate/inform the UE about the total number of last N periods (for example, N=5 periods) for which it was not able transmit BFD RS due to LBT failure.

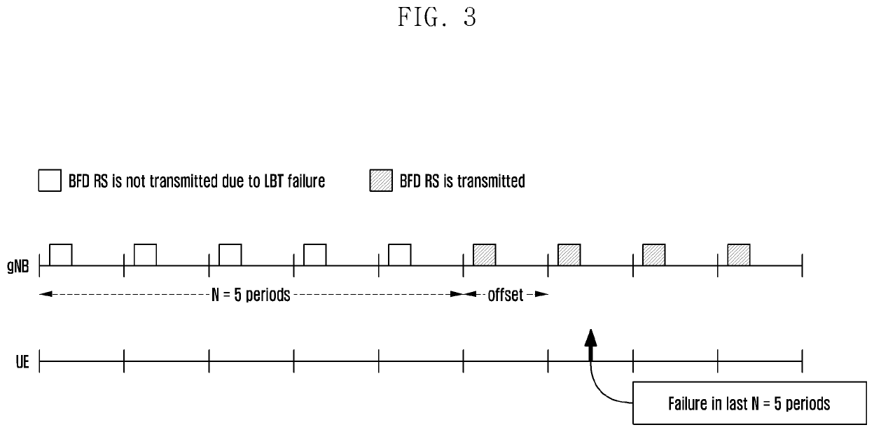

Referring FIG. 3, in an embodiment, the information/indication may be transmitted in period at an offset from last period in which BFD RS is not transmitted after the failure(s). The gNB may indicate/inform the UE about the total number of last N periods (for example, N=5 periods) for which it was not able transmit RS due to LBT failure.

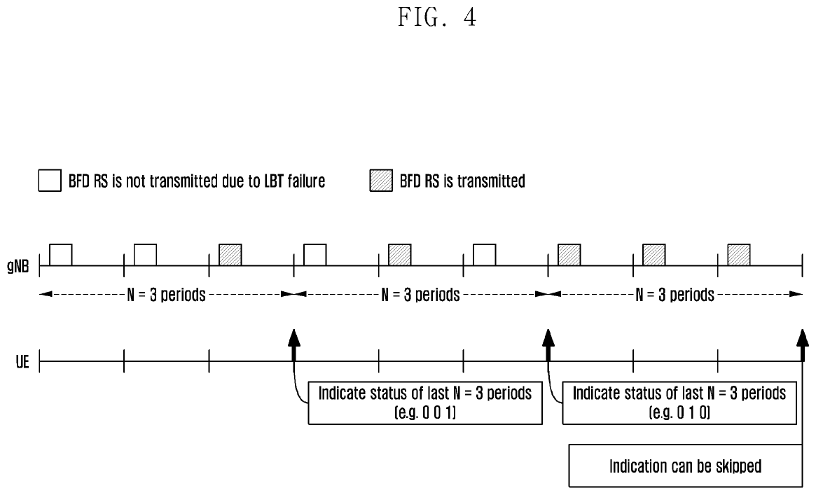

Referring FIG. 4, in an embodiment, the gNB may indicate/inform the UE which of the last N periods (for example, N=3 periods) BFD-RS was not transmitted due to LBT failure. N may be configurable or fixed or dynamic (depending on when network transmits indication). For example, the indication/information may be a bitmap for the N periods, for example, 3-bit bitmap if N=3 periods.

If the bitmap is 001, it indicates that the status of the last 3 periods from which the bitmap is received as:
the first BFD-RS in the last 3 periods is not transmitted due to the LBT failure;
the second BFD-RS in the last 3 periods is not transmitted due to the LBT failure; and
the third BFD-RS in the last 3 periods is transmitted.

If the bitmap is 010, it indicates that the status of the last 3 periods from which the bitmap is received as:
the first BFD-RS in the last 3 periods is not transmitted due to the LBT failure;
the second BFD-RS in the last 3 periods is transmitted; and
the third BFD-RS in the last 3 periods is not transmitted due to the LBT failure.

If all of the BFD-RSs in the last N periods (for example, 3 BFD-RSs in the last 3 periods) are transmitted, the information/indication may be skipped. In other words, none of the BFD-RSs in the last N periods is not transmitted due to the LBT failure, the information/indication may be skipped.

In an embodiment, in case that DCI is used for indicating BFD RS's transmission failure information (as explained above), new PDCCH search space may be configured (e.g., using RRC message) by a gNB to a UE for monitoring the PDCCH for BFD RS's transmission failure information. New RNTI may also be configured (e.g., using RRC message) by the gNB to the UE for monitoring the PDCCH for BFD RS's transmission failures information.

In an embodiment, carrier index/cell index may also be included to indicate the cell/carrier whose BFD RS's transmission failure information is provided by gNB in DCI/MAC CE. Multiple carrier/cells BFD RS's transmission failure information may be included in DCI/MAC CE. Cells/carrier may be from same cell group (CG). Alternately, cells/carrier may be from different CG. Information of BFD RS's transmission failure may also be per TRP if cell supports multiple TRPs. BFD RS's transmission failure information per BFD RS configuration (for example, cell ID, BWP ID, etc) may be included in DCI/MAC CE. BFD RS's transmission failure information of one serving cell may be transmitted by gNB through the DL of another serving cell. The serving cell may be SpCell or SCell.

In an embodiment, based on the received BFD RS's transmission failure information for serving cell or for TRP of serving cell:
if a UE has incremented BFI_COUNTER due to beam failure instance indication corresponding to period for which LBT was failed:
the UE decrements BFI_COUNTER.

The UE may also cancel BFR if it has already triggered the same.

Any SR or RA triggered for BFR is also cancelled.

If this was the last beam failure instance indication, the UE also restores the value of beam failure detection timer. Alternate would be to just restart the timer.

In an alternate embodiment, based on the received BFD RS's transmission failure information for serving cell or for TRP of serving cell: if BFR is not triggered/pending and If UE has incremented BFI counter due to beam failure instance indication corresponding to period for which LBT was failed:
the UE decrements BFI_COUNTER.

If this was the last beam failure instance indication, the UE also restores the value of beam failure detection timer. Alternate would be to just restart the timer.

In an alternate embodiment, based on the received BFD RS's transmission failure information for serving cell or for TRP of serving cell:

If the number of BFD RS periods for which LBT has failed in an evaluation interval is greater than a threshold and If UE has incremented BFI counter due to beam failure instance indication corresponding to that evaluation interval:
the UE decrements BFI_COUNTER; and
the UE may also cancel BFR if it has already triggered the same.

Any SR or RA triggered for BFR is also cancelled.

### Method 2

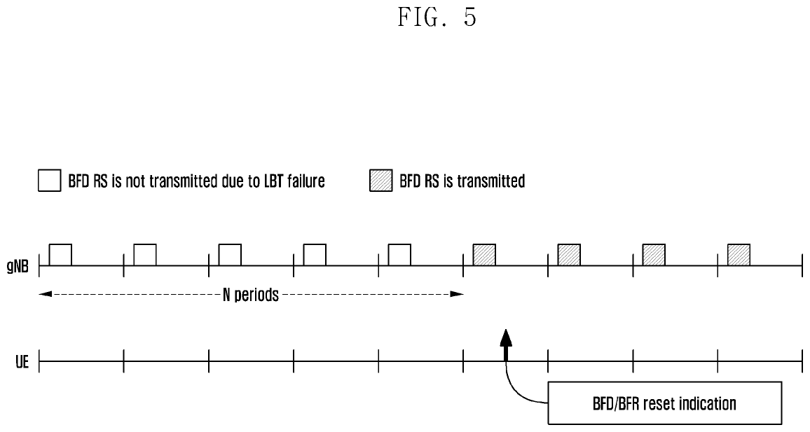

FIG. 5 illustrates an example of a method for communication associated with beam failure detection between a UE and a base station according to an embodiment of the present disclosure.

Referring FIG. 5, connection is established between the UE and the gNB. The UE is configured with one or more serving cells. For detecting beam failure for a serving cell or for detecting beam failure for TRP (or BFD-RS set) of a serving cell, the UE is configured with BFD-RS resource(s). The gNB periodically transmits BFD-RS(s) in these resources. In case that unlicensed spectrum (or frequency or carrier or shared spectrum) is used for a serving cell, the gNB needs to perform LBT operation before transmitting BFD-RS in the BFD-RS resource. In case of LBT failure (i.e., channel is not free for transmitting on BFD-RS resource, the gNB does not transmit BFD-RS in the BFD-RS resource. In case that LBT is successful, the gNB transmits BFD-RS in the BFD-RS resource.

On each BFD-RS resource, the UE estimates the downlink radio link quality and compare it to the thresholds Q_{out_LR}. Qₒᵤₜ is the level at which the downlink radio link cannot be reliably received and corresponds to the block error rate (BLER_{out_LR} of 10%). Beam Failure Instance indication is sent by physical layer (L1) to MAC layer when downlink radio link quality on all the configured BFD-RS resources is worse than Q_{out_LR} If beam failure instance indication has been received from lower layers (i.e., L1), MAC entity performs the following operation:
increment BFI_COUNTER by 1;
if BFI_COUNTER>=beamFailureInstanceMaxCount: trigger BFR;

Referring FIG. 5, in a method of this disclosure, once LBT is successful, in addition to transmitting the BFD RSs, the gNB may indicate/inform the UE to reset the BFI_COUNTER/beamFailureDetectionTimer (e.g., the gNB may indicate/inform the UE to reset the BFI_COUNTER/beamFailureDetectionTimer if number of BFD RS periods (for example, 5 BFD RS periods) for which gNB could not transmit BFD RS due to LBT, is greater than a threshold).

This information/indication may be sent to UE via DCI or MAC CE or RRC message. In an embodiment, the UE may indicate whether it has capability (e.g., using RRC message such as UE capability information message or UE assistance information message or any other message) for such enhancement and if/only if UE has such capability, the gNB provides the above information/indication.

In an embodiment, in case that DCI is used for indicating BFD RS's transmission failure information (as explained above), new PDCCH search space may be configured (e.g., using RRC message) by the gNB to the UE for monitoring the PDCCH for BFD RS's transmission failures information. New RNTI may also be configured (e.g., using RRC message) by the gNB to the UE for monitoring the PDCCH for BFD RS's transmission failure information.

In an embodiment, Carrier index/cell index may also be included to indicate the cell/carrier whose BFD RS's transmission failure information is provided by a gNB in DCI/MAC CE. Multiple carrier/cells BFD RS's transmission failure information can be included in DCI/MAC CE. Cells/carrier may be from same CG. Alternately, cells/carrier may be from different CG. Information of BFD RS's transmission failure may also be per TRP if cell supports multiple TRPs. BFD RS's transmission failure information per BFD RS configuration (for example, cell ID, BWP ID, etc.) may be included in DCI/MAC CE. BFD RS's transmission failure info of one serving cell can be transmitted by the gNB through the DL of another serving cell. The serving cell may be SpCell or SCell.

In an embodiment, based on the received BFD RS's transmission failure information for serving cell or for TRP of serving cell:
the UE reset BFI_COUNTER i.e., set it to zero; and
the UE may also cancel BFR if it has already triggered the same.

Any SR or RA triggered for BFR is also cancelled.

Stop or restart beam failure detection timer.

### Method 3

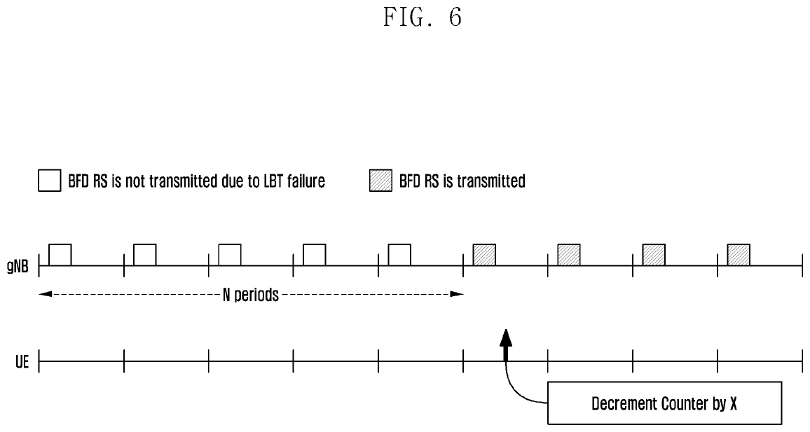

FIG. 6 illustrates an example of a method for communication associated with beam failure detection between a UE and a base station according to an embodiment of the present disclosure.

Referring FIG. 6, connection is established between the UE and the gNB. The UE is configured with one or more serving cells. For detecting beam failure for a serving cell or for detecting beam failure for TRP (or BFD-RS set) of a serving cell, the UE is configured with BFD-RS resource(s). The gNB periodically transmits BFD-RS(s) in these resources. In case that unlicensed spectrum (or frequency or carrier or shared spectrum) is used for a serving cell, the gNB needs to perform LBT operation before transmitting BFD-RS in the BFD-RS resource. In case of LBT failure (i.e., channel is not free for transmitting on BFD-RS resource, the gNB does not transmit BFD-RS in the BFD-RS resource. In case that LBT is successful, the gNB transmits BFD-RS in the BFD-RS resource.

On each BFD-RS resource, the UE estimates the downlink radio link quality and compare it to the thresholds Q_{out_LR}. Qₒᵤₜ is the level at which the downlink radio link cannot be reliably received and corresponds to the block error rate (BLER_{out_LR} of 10%). Beam Failure Instance indication is sent by physical layer (L1) to MAC layer when downlink radio link quality on all the configured BFD-RS resources is worse than Q_{out_LR} If beam failure instance indication has been received from lower layers (i.e., L1), MAC entity performs the following operation:
increment BFI_COUNTER by 1; and
if BFI_COUNTER>=beamFailureInstanceMaxCount: trigger BFR.

Referring FIG. 6, in a method of this disclosure, once LBT is successful, in addition to transmitting the BFD RSs, a gNB may indicate/inform a UE to decrement the BFI_COUNTER by a certain amount (for example, X) (the amount may be configured via RRC message or may be included in indication/information). This information/indication may be sent to UE via DCI or MAC CE or RRC message. In an embodiment, the UE may indicate whether it has capability (e.g., using RRC message such as UE capability information message or UE assistance information message or any other message) for such enhancement and if/only if the UE has such capability, the gNB provides the above information/indication.

In an embodiment, in case that DCI is used for indicating BFD RS's transmission failures information (as explained above), new PDCCH search space may be configured (e.g., using RRC message) by the gNB to the UE for monitoring the PDCCH for BFD RS's transmission failures information. New RNTI may also be configured (e.g., using RRC message) by the gNB to the UE for monitoring the PDCCH for BFD RS's transmission failure information.

In an embodiment, carrier index/cell index may also be included to indicate the cell/carrier whose BFD RS's transmission failure information is provided by the gNB in DCI/MAC CE. Multiple carrier/cells BFD RS's transmission failure information may be included in DCI/MAC CE. Cells/carrier may be from same CG. Alternately, cells/carrier can be from different CG. Information of BFD RS's transmission failure may also be per TRP if cell supports multiple TRPs. BFD RS's transmission failure information per BFD RS configuration (for example, cell ID, BWP ID, etc.) may be included in DCI/MAC CE. BFD RS's transmission failure information of one serving cell may be transmitted by the gNB through the DL of another serving cell. The serving cell may be SpCell or SCell.

In an embodiment, based on the received BFD RS's transmission failure information for serving cell or for TRP of serving cell:
the UE decrement BFI_COUNTER by indicated value; and
the UE may also cancel BFR if it has already triggered the same.

Any SR or RA triggered for BFR is also cancelled.

### Method 4

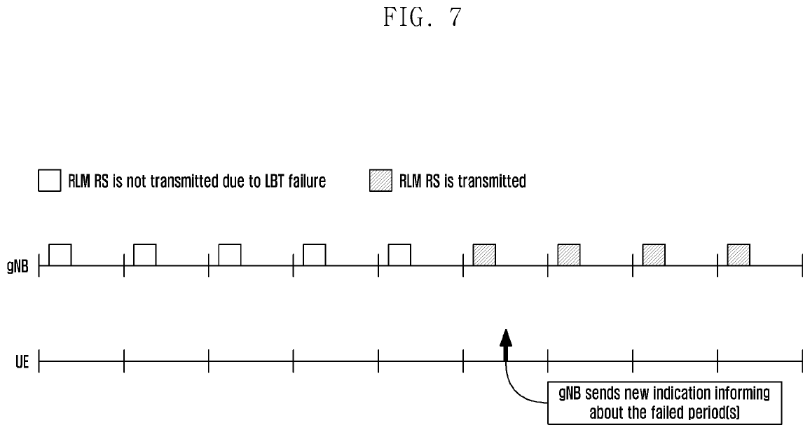

FIGS. 7 through 9 illustrate examples of methods for communication associated with radio link monitoring between a UE and a base station according to an embodiment of the present disclosure.

Referring FIGS. 7-10, connection is established between the UE and the gNB. The UE is configured with one or more serving cells. For detecting radio link failure for a SpCell, the UE is configured with radio link monitoring reference signal (RLM-RS) resource(s). The gNB periodically transmits RLM-RS(s) in these resources. In case that unlicensed spectrum (or frequency or carrier) is used for a serving cell, the gNB needs to perform LBT operation before transmitting RLM-RS in the RLM-RS resource. In case of LBT failure (i.e., channel is not free for transmitting on RLM-RS resource, the gNB does not transmit RLM-RS in the RLM-RS resource. In case that LBT is successful, the gNB transmits RLM-RS in the RLM-RS resource.

On each RLM-RS resource, the UE estimates the downlink radio link quality and compare it to the thresholds Qₒᵤₜ and Qᵢₙ:
Qₒᵤₜ: level at which the downlink radio link cannot be reliably received and corresponds to the out-of-sync block error rate (BLERₒᵤₜ); and
Qᵢₙ: level at which the downlink radio link quality can be received with higher reliability and correspond to the in-sync block error rate (BLERᵢₙ).

BLERₒᵤₜ and BLERᵢₙ is signalled.

Out of sync indication (synchronization indication) is sent by L1 to upper layer if downlink radio link quality on all the configured RLM-RS resources is worse than Qₒᵤₜ. In sync indication is sent by L1 to upper layer if downlink radio link quality on at least one of the configured RLM-RS resources is better than Qᵢₙ.

Upon receiving N310 consecutive “out-of-sync” indications for the SpCell from lower layers while neither T300, T301, T304, T311, T316 nor T319 are running:

A UE starts timer T310 for the corresponding SpCell.

Upon receiving N311 consecutive “in-sync” indications for the SpCell from lower layers while T310 is running, the UE may:
stop timer T310 for the corresponding SpCell.

Upon expiry of T310, the UE declares radio link failure (RLF).

Referring FIG. 7, in a method of this disclosure, the gNB may inform/indicate the UE about the failure of RLM RS transmission(s) (for example, 5 RLM RS transmissions) due to LBT failure. The gNB may inform provide a new indication informing about the failed periods. This information/indication may be sent to the UE via DCI or MAC CE or RRC message. In an embodiment, the UE may indicate whether it has capability (e.g., using RRC message such as UE capability information message or UE assistance information message or any other message) for such enhancement and if/only if the UE has such capability, the gNB provides the above information/indication.

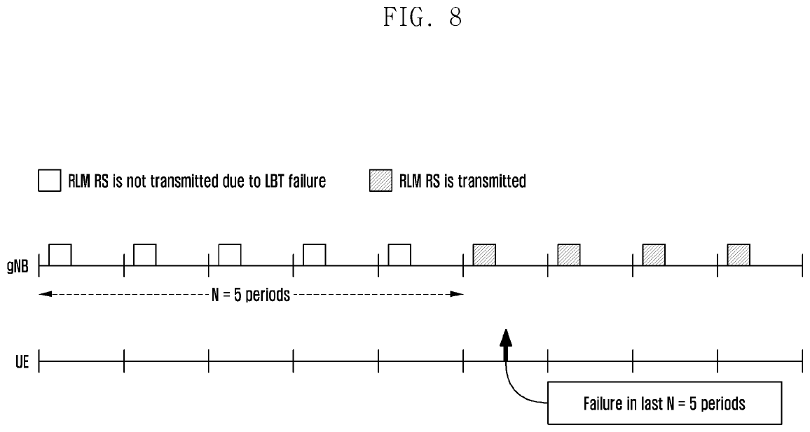

Referring FIG. 8, in an embodiment, the indication/information can be transmitted in first period in which RLM RS is transmitted after the failure(s). The gNB may indicate/inform the UE about the total number of last N periods (for example, N=5 periods) for which it was not able transmit RLM RS due to LBT failure.

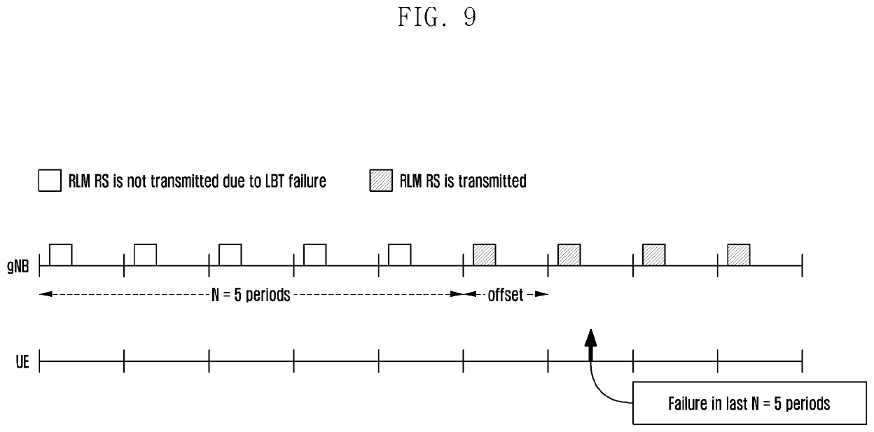

Referring FIG. 9, in an embodiment, the information/indication may be transmitted in period at an offset from last period in which RLM RS is not transmitted after the failure(s). The gNB may indicate/inform the UE about the total number of last N periods (for example, N=5 periods) for which it was not able transmit RS due to LBT failure.

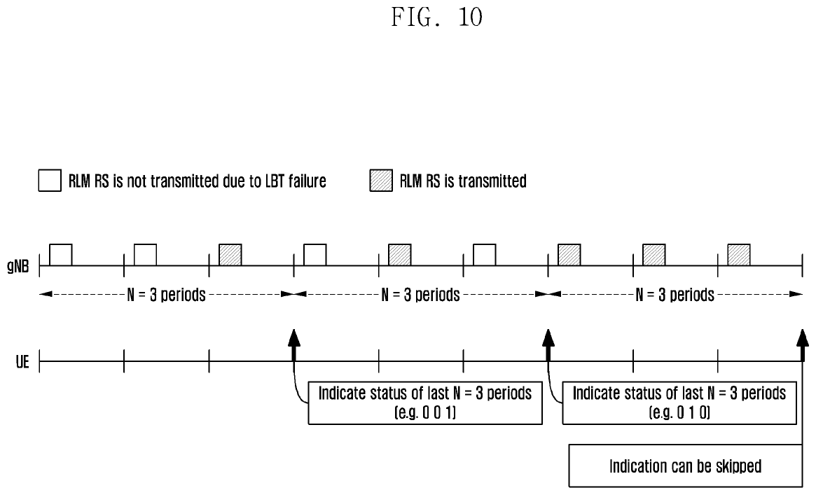

Referring FIG. 10, in an embodiment, the gNB may indicate/inform the UE which of the last N periods (for example, N=3 periods) RLM-RS was not transmitted due to LBT failure. N may be configurable or fixed or dynamic (depending on when network transmits indication). For example, the indication/information may be a bitmap for the N periods, for example, 3-bit bitmap if N=3 periods.

If the bitmap is 001, it indicates that the status of the last 3 periods from which the bitmap is received as:
the first RLM-RS in the last 3 periods is not transmitted due to the LBT failure;
the second RLM-RS in the last 3 periods is not transmitted due to the LBT failure; and
the third RLM-RS in the last 3 periods is transmitted.

If the bitmap is 010, it indicates that the status of the last 3 periods from which the bitmap is received as:
the first RLM-RS in the last 3 periods is not transmitted due to the LBT failure;
the second RLM-RS in the last 3 periods is transmitted; and
the third RLM-RS in the last 3 periods is not transmitted due to the LBT failure.

If all of the RLM-RSs in the last N periods (for example, 3 RLM-RSs in the last 3 periods) are transmitted, the information/indication may be skipped. In other words, none of the RLM-RSs in the last N periods is not transmitted due to the LBT failure, the information/indication may be skipped.

In an embodiment, in case that DCI is used for indicating RLM RS's transmission failure information (as explained above), new PDCCH search space may be configured (e.g., using RRC message) by the gNB to the UE for monitoring the PDCCH for RLM RS's transmission failure information. New RNTI may also be configured (e.g., using RRC message) by the gNB to the UE for monitoring the PDCCH for RLM RS's transmission failure information.

In an embodiment, based on the received RLM RS's transmission failure information for SpCell:

If the UE has incremented out of sync indication count due to out of sync indication corresponding to period for which LBT was failed:
the UE decrements the count of out of sync indication for the SpCell;
the UE may also cancel RLF if it has already triggered the same. The UE may also stop the T310.

In an alternate embodiment, based on the received RLM RS's transmission failure information for SpCell:
if RLF is not triggered and if the UE has incremented out of sync indication count due to out of sync indication corresponding to period for which LBT was failed:
the UE decrements the count of out of sync indication for that SpCell; and
the UE may also cancel RLF if it has already triggered the same. The UE may also stop the T310.

In an alternate embodiment, based on the received RLM RS's transmission failure information for SpCell:

If the number of RLM RS periods for which LBT has failed in an evaluation interval is greater than a threshold and if the UE has incremented out of sync indication count due to out of sync indication corresponding to that evaluation interval:
the UE decrements the count of out of sync indication for that SpCell; and
the UE may also cancel RLF if it has already triggered the same. The UE may also stop the T310.

### Method 5

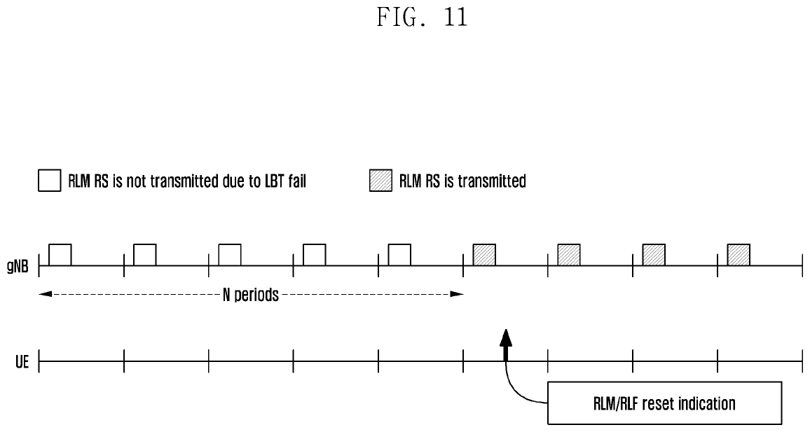

FIG. 11 illustrates an example of a method for communication associated with radio link monitoring between a UE and a base station according to an embodiment of the present disclosure.

Referring FIG. 11, connection is established between the UE and the gNB. The UE is configured with one or more serving cells. For detecting radio link failure for a SpCell, the UE is configured with RLM-RS resource(s). The gNB periodically transmits RLM-RS(s) in these resources. In case that unlicensed spectrum (or frequency or carrier or shared spectrum) is used for a serving cell, the gNB needs to perform LBT operation before transmitting RLM-RS in the RLM-RS resource. In case of LBT failure (i.e., channel is not free for transmitting on RLM-RS resource, the gNB does not transmit RLM-RS in the RLM-RS resource. In case that LBT is successful, the gNB transmits RLM-RS in the RLM-RS resource.

On each RLM-RS resource, the UE estimates the downlink radio link quality and compare it to the thresholds Qₒᵤₜ and Qᵢₙ:
Qₒᵤₜ: level at which the downlink radio link cannot be reliably received and corresponds to the out-of-sync block error rate (BLERₒᵤₜ); and
Qᵢₙ: level at which the downlink radio link quality can be received with higher reliability and correspond to the in-sync block error rate (BLERᵢₙ).

BLERₒᵤₜ and BLERᵢₙ is signalled.

Out of sync indication is sent by L1 to upper layer if downlink radio link quality on all the configured RLM-RS resources is worse than Qₒᵤₜ. In sync indication is sent by L1 to upper layer if downlink radio link quality on at least one of the configured RLM-RS resources is better than Qᵢₙ.

Upon receiving N310 consecutive “out-of-sync” indications for the SpCell from lower layers while neither T300, T301, T304, T311, T316 nor T319 are running:

A UE starts timer T310 for the corresponding SpCell.

Upon receiving N311 consecutive “in-sync” indications for the SpCell from lower layers while T310 is running, the UE may:
stop timer T310 for the corresponding SpCell.

Upon expiry of T310, the UE declares RLF.

Referring FIG. 11, in a method of this disclosure, once LBT is successful, in addition to transmitting the RLM RSs, the gNB may indicate/inform the UE to reset the count of out of sync indications (e.g., the gNB may indicate/inform the UE to reset the count of out of sync indications if number of RLM RS periods (for example, 5 RLM RS periods) for which the gNB could not transmit RLM RS due to LBT, is greater than a threshold).

This information/indication may be sent to the UE via DCI or MAC CE or RRC message. In an embodiment, the UE may indicate whether it has capability (e.g., using RRC message such as UE capability information message or UE assistance information message or any other message) for such enhancement and if/only if the UE has such capability, the gNB provides the above information/indication.

In an embodiment, in case that DCI is used for indicating RLM RS's transmission failure information (as explained above), new PDCCH search space may be configured (e.g., using RRC message) by the gNB to the UE for monitoring the PDCCH for RLM RS's transmission failures information. New RNTI may also be configured (e.g., using RRC message) by the gNB to the UE for monitoring the PDCCH for RLM RS's transmission failures information.

In an embodiment, based on the received RLM RS's transmission failure information for SpCell:
the UE decrements the count of out of sync indication for that SpCell; and
the UE may also cancel RLF if it has already triggered the same. The UE may also stop the T310.

### Method 6

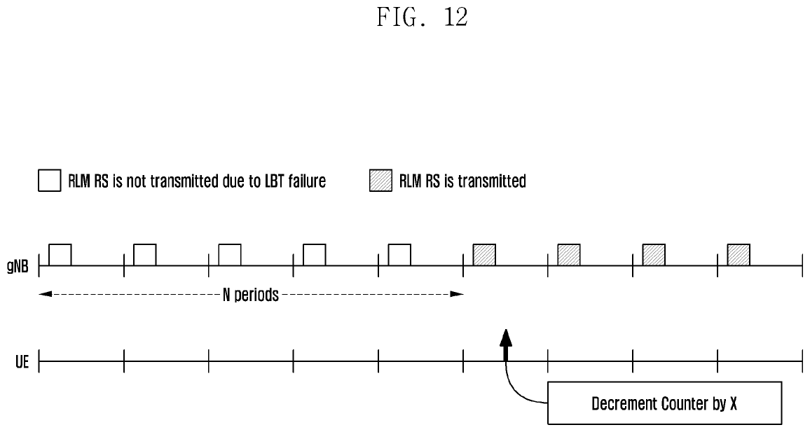

FIG. 12 illustrates an example of a method for communication associated with radio link monitoring between a UE and a base station according to an embodiment of the present disclosure.

Referring FIG. 12, connection is established between the UE and the gNB. The UE is configured with one or more serving cells. For detecting radio link failure for a SpCell, the UE is configured with RLM-RS resource(s). The gNB periodically transmits RLM-RS(s) in these resources. In case that unlicensed spectrum (or frequency or carrier or shared spectrum) is used for a serving cell, the gNB needs to perform LBT operation before transmitting RLM-RS in the RLM-RS resource. In case of LBT failure (i.e., channel is not free for transmitting on RLM-RS resource, the gNB does not transmit RLM-RS in the RLM-RS resource. In case that LBT is successful, the gNB transmits RLM-RS in the RLM-RS resource.

On each RLM-RS resource, the UE estimates the downlink radio link quality and compare it to the thresholds Qₒᵤₜ and Qᵢₙ:
Qₒᵤₜ: level at which the downlink radio link cannot be reliably received and corresponds to the out-of-sync block error rate (BLERₒᵤₜ); and
Qᵢₙ: level at which the downlink radio link quality can be received with higher reliability and correspond to the in-sync block error rate (BLERin).

BLERₒᵤₜ and BLERᵢₙ is signalled.

Out of sync indication is sent by L1 to upper layer if downlink radio link quality on all the configured RLM-RS resources is worse than Qₒᵤₜ. In sync indication is sent by L1 to upper layer if downlink radio link quality on at least one of the configured RLM-RS resources is better than Qᵢₙ.

Upon receiving N310 consecutive “out-of-sync” indications for the SpCell from lower layers while neither T300, T301, T304, T311, T316 nor T319 are running:

A UE starts timer T310 for the corresponding SpCell.

Upon receiving N311 consecutive “in-sync” indications for the SpCell from lower layers while T310 is running, the UE may:
stop timer T310 for the corresponding SpCell.

Upon expiry of T310, the UE declares RLF.

Referring FIG. 12, in a method of this disclosure, once LBT is successful, in addition to transmitting the RLM RSs, the gNB may indicate/inform the UE to decrement the count of out of sync indication by a certain amount (the amount can be configured via RRC message or can be included in indication/information). This information/indication may be sent to the UE via DCI or MAC CE or RRC message. In an embodiment, the UE may indicate whether it has capability (e.g., using RRC message such as UE capability information message or UE assistance information message or any other message) for such enhancement and if/only if the UE has such capability, the gNB provides the above information/indication.

In an embodiment, in case that DCI is used for indicating RLM RS's transmission failures information (as explained above), new PDCCH search space may be configured (e.g., using RRC message) by the gNB to the UE for monitoring the PDCCH for RLM RS's transmission failure information. New RNTI may also be configured (e.g., using RRC message) by the gNB to the UE for monitoring the PDCCH for RLM RS's transmission failure information.

RLM RS's transmission failure information of SpCell may be transmitted by the gNB through the DL of SCell. In an embodiment, based on the received RLM RS's transmission failure information of SpCell:
the UE decrements the count of out of sync indication for that SpCell; and
the UE may also cancel RLF if it has already triggered the same. The UE may also stop the T310.

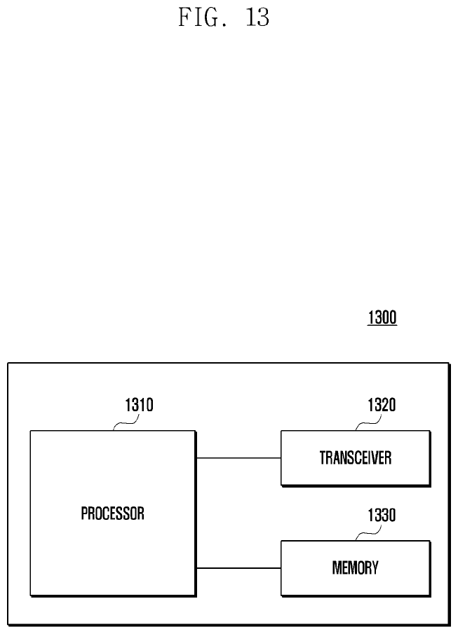

FIG. 13 illustrates an electronic device according to embodiments of the present disclosure.

Referring to the FIG. 13, the electronic device 1300 may include a processor 1310, a transceiver 1320 and a memory 1330. However, all of the illustrated components are not essential. The electronic device 1300 may be implemented by more or less components than those illustrated in FIG. 13. In addition, the processor 1310 and the transceiver 1320 and the memory 1330 may be implemented as a single chip according to another embodiment.

The electronic device 1300 may correspond to the UE described above.

The aforementioned components will now be described in detail.

The processor 1310 may include one or more processors or other processing devices that control the provided function, process, and/or method. Operation of the electronic device 1300 may be implemented by the processor 1310.

The transceiver 1320 may include a RF transmitter for up-converting and amplifying a transmitted signal, and a RF receiver for down-converting a frequency of a received signal. However, according to another embodiment, the transceiver 1320 may be implemented by more or less components than those illustrated in components.

The transceiver 1320 may be connected to the processor 1310 and transmit and/or receive a signal. The signal may include control information and data. In addition, the transceiver 1320 may receive the signal through a wireless channel and output the signal to the processor 1310. The transceiver 1320 may transmit a signal output from the processor 1310 through the wireless channel.

The memory 1330 may store the control information or the data included in a signal obtained by the electronic device 1300. The memory 1330 may be connected to the processor 1310 and store at least one instruction or a protocol or a parameter for the provided function, process, and/or method. The memory 1330 may include read-only memory (ROM) and/or random access memory (RAM) and/or hard disk and/or CD-ROM and/or DVD and/or other storage devices.

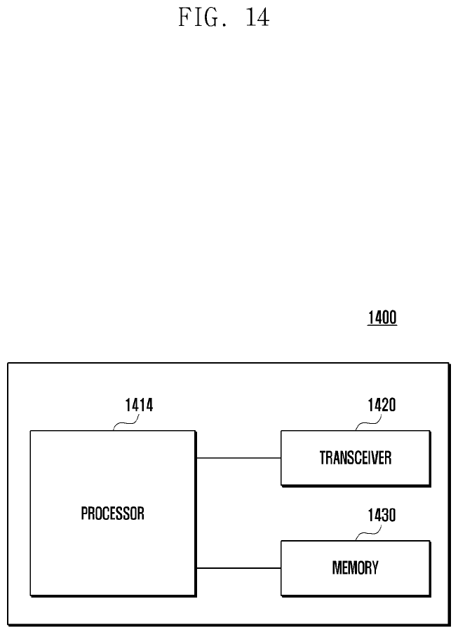

FIG. 14 illustrates a base station according to embodiments of the present disclosure.

Referring to the FIG. 14, the base station 1400 may include a processor 1410, a transceiver 1420 and a memory 1430. However, all of the illustrated components are not essential. The base station 1400 may be implemented by more or less components than those illustrated in FIG. 14. In addition, the processor 1410 and the transceiver 1420 and the memory 1430 may be implemented as a single chip according to another embodiment.

The base station 1400 may correspond to the gNB described above.

The aforementioned components will now be described in detail.

The processor 1410 may include one or more processors or other processing devices that control the provided function, process, and/or method. Operation of the base station 1400 may be implemented by the processor 1410.

The transceiver 1420 may include a RF transmitter for up-converting and amplifying a transmitted signal, and a RF receiver for down-converting a frequency of a received signal. However, according to another embodiment, the transceiver 1420 may be implemented by more or less components than those illustrated in components.

The transceiver 1420 may be connected to the processor 1410 and transmit and/or receive a signal. The signal may include control information and data. In addition, the transceiver 1420 may receive the signal through a wireless channel and output the signal to the processor 1410. The transceiver 1420 may transmit a signal output from the processor 1410 through the wireless channel.

The memory 1430 may store the control information or the data included in a signal obtained by the base station 1400. The memory 1430 may be connected to the processor 1410 and store at least one instruction or a protocol or a parameter for the provided function, process, and/or method. The memory 1430 may include read-only memory (ROM) and/or random access memory (RAM) and/or hard disk and/or CD-ROM and/or DVD and/or other storage devices.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored n non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiment to operate a base station and a terminal.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Any of the above variation embodiments can be utilized independently or in combination with at least one other variation embodiment. The above flowchart(s) illustrate example methods that can be implemented in accordance with the principles of the disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the disclosure has been described with exemplary embodiments, various changes and modifications may be suggested to one skilled in the art. It is intended that the disclosure encompass such changes and modifications as fall within the scope of the appended claims. None of the descriptions in this application should be read as implying that any particular element, step, or function is an essential element that must be included in the claims scope. The scope of patented subject matter is defined by the claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a communication system, the method comprising:
receiving configuration information associated with a beam failure recovery (BFR) including beam failure detection reference signal (BFD-RS) resources, wherein the BFD-RS resources are configured in an unlicensed band;
identifying a first number of beam failure instance indications (BFIs) based on radio link quality associated with the BFD-RS resources;
incrementing a BFI counter by the first number; and
decrementing the incremented BFI counter in case that information associated with a second number of periods for the BFD-RS resources is received, wherein at least part of the second number of periods is associated with listen before talk (LBT) failure.

2. The method of claim 1, wherein decrementing the incremented BFI counter is performed based on the incremented BFI counter being less than a configured maximum BFI counter,
wherein the incremented BFI counter is decremented by a number of BFIs identified based on the information associated with the second number of periods, and
wherein a beam failure detection timer is restored or restarted in case that the first number of BFIs includes a last BFI.

3. The method of claim 2, further comprising:
triggering the BFR in case that the BFI counter reaches a value equal to or higher than the maximum BFI counter; and
cancelling the BFR based on the information associated with the second number of periods is received,
wherein the BFI counter is incremented until the BFI counter reaches the value equal to or higher than the configured maximum BFI counter.

4. The method of claim 1, wherein the information associated with the second number is received in:
a period of for the BFD-RS resources after a last period of the second number of periods; or
a period of for the BFD-RS resources after an offset from the last period of the second number of periods.

5. The method of claim 1, wherein the information associated with the second number of periods is a bitmap of the second number of bits, wherein each bit of the second number of bits corresponds to the second number of periods,
wherein a bit with a first value among the second number of bits indicates that a BFD-RS resource in a corresponding period among the second number of periods is associated with the LBT failure, and
wherein a bit with a second value among the second number of bits indicates that a BFD-RS resource in a corresponding period among the second number of periods is associated with LBT success.

6. A user equipment (UE) in a communication system, the UE comprising:
a transceiver; and
a processor coupled with the transceiver and configured to:
receive configuration information associated with beam failure recovery (BFR) including beam failure detection reference signal (BFD-RS) resources, wherein the BFD-RS resources are configured in an unlicensed band;
identify a first number of beam failure instance indications (BFIs) based on radio link quality associated with the BFD-RS resources;
increment a BFI counter by the first number; and
decrement the incremented BFI counter in case that information associated with a second number of periods for the BFD-RS resources is received, wherein at least part of the second number of periods is associated with listen before talk (LBT) failure.

7. The UE of claim 6, wherein decrementing the incremented BFI counter is performed based on the incremented BFI counter being less than a configured maximum BFI counter,
wherein the incremented BFI counter is decremented by a number of BFIs identified based on the information associated with the second number of periods, and
wherein a beam failure detection timer is restored or restarted in case that the first number of BFIs includes a last BFI.

8. The UE of claim 7, wherein the BFI counter is incremented until the BFI counter reaches a value equal to or higher than the configured maximum BFI counter, and
wherein the processor is further configured to:
trigger the BFR in case that the BFI counter reaches the value equal to or higher than the maximum BFI counter; and
cancel the BFR based on the information associated with the second number of periods is received.

9. The UE of claim 6, wherein the information associated with the second number is received in:
a period of for the BFD-RS resources after a last period of the second number of periods; or
a period of for the BFD-RS resources after an offset from the last period of the second number of periods.

10. The UE of claim 6, wherein the information associated with the second number of periods is a bitmap of the second number of bits, wherein each bit of the second number of bits corresponds to the second number of periods,
wherein a bit with a first value among the second number of bits indicates that a BFD-RS resource in a corresponding period among the second number of periods is associated with the LBT failure, and
wherein a bit with a second value among the second number of bits indicates that a BFD-RS resource in a corresponding period among the second number of periods is associated with LBT success.

11. A method performed by a base station in a communication system, the method comprising:
transmitting configuration information associated with beam failure recovery (BFR) including beam failure detection reference signal (BFD-RS) resources, wherein the BFD-RS resources are configured in an unlicensed band;
performing a listen before talk (LBT) operation for transmissions of the BFD-RS resources; and
determining whether to perform the transmissions of the BFD-RS resources based on the LBT operation,
wherein a first number of beam failure instance indications (BFIs) is based on radio link quality associated with the BFD-RS resources,
wherein the first number is for increment of a BFI counter, and
wherein information associated with a second number of periods for the BFD-RS resources is transmitted and at least part of the second number of periods is associated with LBT failure, and
wherein the information associated with the second number of periods is for decrement of the incremented BFI counter.

12. The method of claim 11, wherein the decrement of the incremented BFI counter is based on the incremented BFI counter being less than a configured maximum BFI counter, and
wherein the information associated with the second number of periods is associated with a number of BFIs for the decrement of the incremented BFI counter.

13. The method of claim 11, wherein the information associated with the second number is transmitted in a period of for the BFD-RS resources after a last period of the second number of periods.

14. The method of claim 11, wherein the information associated with the second number is transmitted in a period of for the BFD-RS resources after an offset from a last period of the second number of periods.

15. The method of claim 11, wherein the information associated with the second number of periods is a bitmap of the second number of bits, wherein each bit of the second number of bits corresponds to the second number of periods,
wherein a bit with a first value among the second number of bits indicates that a BFD-RS resource in a corresponding period among the second number of periods is not transmitted due to the LBT failure, and
wherein a bit with a second value among the second number of bits indicates that a BFD-RS resource in a corresponding period among the second number of periods is transmitted.

16. A base station in a communication system, the base station comprising:
a transceiver; and
a processor coupled with the transceiver and configured to:
transmit configuration information associated with beam failure recovery (BFR) including beam failure detection reference signal (BFD-RS) resources, wherein the BFD-RS resources are configured in an unlicensed band;
perform a listen before talk (LBT) operation for transmissions of the BFD-RS resources; and
determine whether to perform the transmissions of the BFD-RS resources based on the LBT operation,
wherein a first number of beam failure instance indications (BFIs) is based on radio link quality associated with the BFD-RS resources,
wherein the first number is for increment of a BFI counter, and
wherein information associated with a second number of periods for the BFD-RS resources is transmitted and at least part of the second number of periods is associated with LBT failure, and
wherein the information associated with the second number of periods is for decrement of the incremented BFI counter.

17. The base station of claim 16, wherein the decrement of the incremented BFI counter is based on the incremented BFI counter being less than a configured maximum BFI counter, and
wherein the information associated with the second number of periods is associated with a number of BFIs for the decrement of the incremented BFI counter.

18. The base station of claim 16, wherein the information associated with the second number is transmitted in a period of for the BFD-RS resources after a last period of the second number of periods.

19. The base station of claim 16, wherein the information associated with the second number is transmitted in a period of for the BFD-RS resources after an offset from a last period of the second number of periods.

20. The base station of claim 16, wherein the information associated with the second number of periods is a bitmap of the second number of bits, wherein each bit of the second number of bits corresponds to the second number of periods,
wherein a bit with a first value among the second number of bits indicates that a BFD-RS resource in a corresponding period among the second number of periods is not transmitted due to the LBT failure, and
wherein a bit with a second value among the second number of bits indicates that a BFD-RS resource in a corresponding period among the second number of periods is transmitted.
